(19) United States
(12) Patent Application Publication
(10) Pub. No.: US 2026/0168609 A1
(43) Pub. Date: Jun. 18, 2026

(54) A TRACTOR FOR PROPELLING AN APPARATUS INSIDE A CYLINDRICAL BODY

(71) Applicant: PIPESNAKE AS, Stavanger (NO)

(72) Inventor: Bjarne LANGETEIG, Tananger (NO)

(21) Appl. No.: 19/125,200

(22) PCT Filed: Nov. 8, 2023
(86) PCT No.: PCT/EP2023/081082

§ 371 Date: Apr. 28, 2025

(30) Foreign Application Priority Data
Nov. 9, 2022 (NO) 20221204
Nov. 15, 2022 (NO) 20221225

(51) Int. Cl. F16L 55/30

(52) U.S. Cl. CPC F16L 55/30

(57) ABSTRACT

The present disclosure relates to a tractor (10) for propelling an apparatus (108) inside a cylindrical body (60), the tractor (10) comprising a fluid motor (14) comprising a fluid motor fluid inlet (16) and a fluid motor fluid exhaust (18), wherein the tractor (10) further comprises a set of drive portions (20) comprising at least one drive portion (22, 24) wherein each drive portion (22, 24) in the set of drive portions (20) comprises: ⋅ a drive shaft (26, 28) connected to the fluid motor (14) whereby the drive shaft (26, 28) is adapted to be rotated around an axis of rotation (30, 32) of the drive shaft (26, 28), ⋅ a set of propulsion members (34, 36) comprising at least one propulsion member (12), preferably two or more propulsion members, each propulsion member (12) in the set of propulsion members (34, 36) being rotationally fixed to the drive shaft (26, 28); ⋅ a fluid actuated control assembly (38, 40) adapted to control a largest distance (54), in a direction perpendicular to the axis of rotation (30, 32) of the drive shaft (26, 28), from the drive shaft (26, 28) to each propulsion member (12) in the set of propulsion members (34, 36), ⋅ the control assembly (38, 40) being adapted to be at least selectively in fluid communication with at least one of the fluid motor fluid inlet (16) and the fluid motor fluid exhaust (18).

### TECHNICAL FIELD

The present disclosure relates to a tractor for propelling an apparatus inside a cylindrical body. Moreover, the present disclosure relates to an apparatus comprising the tractor.

### BACKGROUND

Contemporary technologies employ several different mechanisms for performing operations inside a cylindrical body, such as oil and gas wells, water injection and production pipelines. One such mechanism is a pipeline tractor. Pipeline tractors employ different mechanisms for propulsion or movements of the tractors inside a cylindrical or an elongated body.

In an example, pipeline tractors may be employed in oil and gas wells for inspection and maintenance of pipelines or hoses. These tractors are designed and built specifically for offshore use and for transporting equipment through wells. The tractors may not always be suitable for other applications such as maintenance of water pipes etc. Further, tractors in market for oil and gas wells are designed to operate in horizontal sections of wellbores.

WO 2022/129328 A1 discloses an apparatus for propulsion and operations inside a cylindrical body, such as a pipeline, and comprises a central shaft, at least one motor and motor control unit, a number of wheels arranged to rotate round the shaft with a tilted angle, and a sensor module comprising sensors. However, there is still a need for improving tractors for propelling an apparatus inside a cylindrical body.

### SUMMARY

In view of the above, an object of the present disclosure is to provide a tractor for propelling an apparatus inside a cylindrical body, which tractor can be controlled in an appropriate manner.

The above object is obtained by a first aspect of the present disclosure in accordance with claim 1.

As such, a first aspect of the present disclosure relates to a tractor for propelling an apparatus inside a cylindrical body. The tractor comprises a fluid motor comprising a fluid motor fluid inlet and a fluid motor fluid exhaust. The tractor further comprises a set of drive portions comprising at least one drive portion. Each drive portion in the set of drive portions comprises:
a drive shaft connected to the fluid motor whereby the drive shaft is adapted to be rotated around an axis of rotation of the drive shaft,
a set of propulsion members comprising at least one propulsion member, preferably two or more propulsion members, each propulsion member in the set of propulsion members being rotationally fixed to the drive shaft;
a fluid actuated control assembly adapted to control a largest distance, in a direction perpendicular to the axis of rotation of the drive shaft, from the drive shaft to each propulsion member in the set of propulsion members,
the control assembly being adapted to be at least selectively in fluid communication with at least one of the fluid motor fluid inlet and the fluid motor fluid exhaust.

A tractor according to the above implies that a single fluid flow may be used for actuating the fluid motor and for controlling the control assembly. This in turn implies an appropriately low need for conduits, cables or the like for controlling the tractor.

Optionally, the set of drive portions comprises at least two drive portions, namely a first drive portion and a second drive portion. The use of two drive portions implies that an appropriately high propulsion force may be achieved.

Optionally, the fluid motor comprises a stator and a rotor, wherein the drive shaft of one of the first drive portion and the second drive portion is rotationally connected to the stator and the drive shaft of the other one of the first drive portion and the second drive portion is rotationally connected to the rotor. The above implies that the first drive portion and the second drive portion during operation of the fluid motor may have similar rotational speeds but in opposite directions. This in turn implies that the tractor as such is less prone to being rotated during use and such a characteristic may be achieved by a relatively low number of components since the first and second drive portions are connected to the stator and rotor.

Optionally, the fluid actuated control assembly of one of the first drive portion and the second drive portion is adapted to be at least selectively in fluid communication with the fluid motor fluid inlet and the fluid actuated control assembly of the other one of the first drive portion and the second drive portion is adapted to be at least selectively in fluid communication with the fluid motor fluid exhaust. This implies a compact tractor in which fluid conduits may be arranged in a straightforward manner.

Optionally, each propulsion member in the set of propulsion members of the first drive portion is adapted to rotate in a rotational direction opposite to the rotational direction of each propulsion member in the set of propulsion members of the second drive portion. Rotations in opposite directions imply that the first and second drive portion together do not produce a large torque that will rotate the tractor or any portion of the apparatus relative to the cylindrical body.

Optionally, the tractor extends along a longitudinal extension in a longitudinal direction. The set of propulsion members of the first drive portion and the set of propulsion members of the second drive portion are located on opposite sides of the fluid motor in the longitudinal direction.

Optionally, the axis of rotation of the drive shaft of the first drive portion and the axis of rotation of the drive shaft of the second drive portion form an angle having an absolute value being less than 10°. Preferably, the axis of rotation of the drive shaft of the first drive portion is parallel to and/or coaxial with the axis of rotation of the drive shaft of the second drive portion.

Optionally, at least one drive portion, preferably each drive portion, in the set of drive portions comprises a fluid flow control assembly adapted to control a flow of fluid from one of the fluid motor fluid inlet and the fluid motor fluid exhaust to the fluid actuated control assembly. The fluid flow control assembly implies an appropriate control of the fluid flow to the fluid actuated control assembly.

Optionally, the fluid flow control assembly comprises an inlet pressure relief valve comprising an inlet pressure relief valve inlet being in fluid communication with one of the fluid motor fluid inlet and the fluid motor fluid exhaust. The inlet pressure relief valve is adapted to allow fluid passage via the inlet pressure relief valve when a fluid pressure acting on the inlet pressure relief valve inlet is equal to or exceeds a threshold inlet pressure and to prevent fluid passage via the inlet pressure relief valve when the fluid pressure acting on the inlet pressure relief valve inlet is lower than the threshold inlet pressure. The above implies an appropriately high possibility to control the flow of fluid from one of the fluid motor fluid inlet and the fluid motor fluid exhaust to the control assembly. This is since the fluid pressure level may be used for controlling whether or not fluid should pass the inlet pressure relief valve and thus proceed towards the control assembly.

Optionally, the inlet pressure relief valve is adapted to receive a threshold inlet pressure signal, indicative of a requested threshold inlet pressure, and to set the threshold inlet pressure on the basis of the threshold inlet pressure signal. Such a control of the threshold inlet pressure implies an appropriate versatility in the control of the inlet pressure relief valve and thus of the tractor.

Optionally, the inlet pressure relief valve comprises an inlet pressure relief valve outlet. The fluid flow control assembly comprises an outlet pressure relief valve comprising an outlet pressure relief valve inlet being in fluid communication with the inlet pressure relief valve outlet. The outlet pressure relief valve is adapted to allow fluid passage via the outlet pressure relief valve when a fluid pressure acting on the outlet pressure relief valve inlet is equal to or exceeds a threshold outlet pressure and to prevent fluid passage via the outlet pressure relief valve when the fluid pressure acting on the outlet pressure relief valve inlet is lower than the threshold outlet pressure. Preferably, the outlet pressure relief valve comprises an outlet pressure relief valve outlet being in fluid communication with the environment ambient of the tractor. The outlet pressure relief valve implies an appropriately low risk that fluid having too high pressure is fed towards the control assembly and this in turn implies an appropriately low risk of damaging the control assembly.

Optionally, the outlet pressure relief valve is adapted to receive a threshold outlet pressure signal, indicative of a requested threshold outlet pressure, and to set the threshold outlet pressure on the basis of the threshold outlet pressure signal. Such a control of the threshold outlet pressure implies an appropriate versatility in the control of the outlet pressure relief valve and thus of the tractor.

Optionally, the fluid flow control assembly comprises an internal throttling adapted to throttle a fluid flow from the inlet pressure relief valve outlet to the outlet pressure relief valve inlet. Preferably the internal throttling is an adjustable internal throttling.

Optionally, the fluid flow control assembly comprises a fluid flow control assembly exhaust downstream the control assembly, as seen in a direction of flow to the control assembly from one of the fluid motor fluid inlet and the fluid motor fluid exhaust, the fluid flow control assembly exhaust being adapted to discharge fluid to the environment ambient of the tractor.

Optionally, the inlet pressure relief valve comprises an inlet pressure relief valve outlet being in constant fluid communication with the fluid flow control assembly exhaust. This implies an appropriate possibility to control the control assembly by means of one or more characteristics, such as the pressure, of the fluid fed to the inlet pressure relief valve. As such, rather than furnishing the tractor with a diverting valve, a selection valve or the like which needs to be controlled by a signal, the above constant fluid communication implies that the fluid fed to the inlet pressure relief valve may be used for controlling the control assembly.

Optionally, the fluid flow control assembly exhaust comprises an exhaust throttling adapted to throttle the fluid discharged to the environment ambient of the tractor. A filter is an option, and throttling may be a manually controlled choke screw, for instance combined with an exhaust pop-off valve.

Optionally, the tractor comprises a fluid guide conduit adapted to guide fluid to the fluid motor fluid inlet.

Optionally, the inlet pressure relief valve inlet is in fluid communication with the fluid guide conduit.

Optionally, for at least one drive portion, preferably each drive portion, in the set of drive portions, each propulsion member in the set of propulsion members comprises a rim enclosing the drive shaft. Preferably each propulsion member in the set of propulsion members comprises a wheel that in turn comprises the rim. When each propulsion member of a set of propulsion members comprises a rim, the control assembly may be adapted to control the eccentricity of the rim of each propulsion member relative to the drive shaft to thereby control the largest distance, in a direction perpendicular to the axis of rotation of the drive shaft, from the drive shaft to each propulsion member in the set of propulsion members.

Optionally, the fluid actuated control assembly is adapted to control an eccentricity of the rim relative to the drive shaft to thereby control the largest distance, in a direction perpendicular to the axis of rotation of the drive shaft, from the drive shaft to each propulsion member in the set of propulsion members.

Optionally, the rim extends in a rim plane. The rim plane forms a rim angle with the axis of rotation of the drive shaft. The rim angle is less than 90°, preferably less than 88°, more preferred less than 85°.

Optionally, for at least one drive portion, preferably each drive portion, in the set of drive portions, the control assembly comprises a fluid-controlled actuator, preferably a cylinder, adapted to increase the largest distance, in a direction perpendicular to the axis of rotation of the drive shaft, from the drive shaft to each propulsion member in the set of propulsion members, when fluid fed to the fluid-controlled actuator is equal to or above a fluid control threshold pressure.

Optionally, the control assembly comprises a set of fluid-controlled actuators, such that each propulsion member in the set of propulsion members is connected to an individual fluid-controlled actuator in the set of fluid-controlled actuators. Each fluid-controlled actuator in the set of fluid-controlled actuators is adapted to increase the largest distance, in a direction perpendicular to the axis of rotation of the drive shaft, from the drive shaft to an individual propulsion member in the set of propulsion members, when fluid fed to the fluid-controlled actuator is equal to or above a fluid control threshold pressure.

Optionally, the control assembly comprises a biasing arrangement adapted to bias each propulsion member in the set of propulsion members towards a position with a minimum largest distance, in a direction perpendicular to the axis of rotation of the drive shaft, from the drive shaft to the propulsion member.

Optionally, the cylindrical body has a longitudinal extension in a longitudinal cylindrical body direction. The tractor is adapted to propel the apparatus in a direction parallel to and/or coaxial with the longitudinal cylindrical body direction.

Optionally, for at least one drive portion, preferably each drive portion, in the set of drive portions, when in use, the axis of rotation of the drive shaft and the longitudinal cylindrical body direction form an angle having an absolute value being less than 10°. Preferably, the axis of rotation of the drive shaft is parallel to the longitudinal cylindrical body direction.

Optionally, for at least one drive portion, preferably each drive portion, in the set of drive portions, each propulsion member in the set of propulsion members comprises a propulsion member contact portion adapted to contact an inner surface of the cylindrical body. The largest distance from the drive shaft to the propulsion member is a distance from the drive shaft to the propulsion member contact portion in the direction perpendicular to the axis of rotation of the drive shaft.

Optionally, for at least one drive portion, preferably each drive portion, in the set of drive portions, each propulsion member in the set of propulsion members is adapted to transfer a force from an inner surface of the cylindrical body to the drive shaft when the largest distance is equal to or above a largest distance threshold. The above implies that the propulsion member may be brought into contact with the inner surface of the cylindrical body by increasing the largest distance.

Optionally, for at least one drive portion, preferably each drive portion, in the set of drive portions, each propulsion member in the set of propulsion members is such that when the drive shaft rotates around the axis of rotation and the propulsion member transfers a force from the inner surface of the cylindrical body to the drive shaft, a propulsion force is imparted on the tractor.

Optionally, for at least one drive portion, preferably each drive portion, in the set of drive portions, each propulsion member in the set of propulsion members is such that when the drive shaft rotates around the axis of rotation and the propulsion member transfers a force from the inner surface of the cylindrical body to the drive shaft, a contact point between the propulsion member and the inner surface of the cylindrical body will vary as the drive shaft rotates around the axis of rotation such that a trajectory of subsequent contact points will form a helical shape on the inner surface of the cylindrical body.

A second aspect of the present disclosure relates to a tractor assembly comprising a tractor according to the first aspect of the present disclosure and a source of pressurized fluid, preferably a pump. The source of pressurized fluid is in fluid communication with the fluid guide conduit.

A third aspect of the present disclosure relates to an apparatus comprising the tractor according to the first aspect of the present disclosure or a tractor assembly according to the second aspect of the present disclosure.

A fourth aspect of the present disclosure relates to a cylindrical body assembly comprising a cylindrical body and the tractor according to the first aspect of the present disclosure, a tractor assembly according to the second aspect of the present disclosure or an apparatus according to the third aspect of the present disclosure.

Optionally, the apparatus further comprises a sensor and/or a tool.

### BRIEF DESCRIPTION OF THE DRAWINGS

With reference to the appended drawings, below follows a more detailed description of embodiments of the disclosure cited as examples.

In the Drawings:

FIG. 1 is a schematic perspective view of a tractor for propelling an apparatus inside a cylindrical body;

FIG. 2 is a schematic perspective view of a tractor for propelling an apparatus inside a cylindrical body;

FIG. 3 is an exploded view of the tractor presented in FIG. 2;

FIGS. 4a-4d illustrate an implementation of a fluid actuated control assembly;

FIG. 5a illustrates another implementation of a fluid actuated control assembly;

FIG. 5b illustrates a helical shape;

FIG. 6 illustrates schematically a hydraulic system of a tractor for propelling an apparatus inside a cylindrical body;

FIG. 7a-7b illustrates the operation of a tractor for propelling an apparatus inside a cylindrical body;

FIGS. 8a-8b illustrate sectional views of a hydraulic fluid flow line of a tractor for propelling an apparatus inside a cylindrical body;

FIGS. 9a-9b illustrate a sectional view of front and the rear stator shafts of a tractor for propelling an apparatus inside a cylindrical body, and

FIGS. 10a-10c illustrate add-ons to a tractor for propelling an apparatus inside a cylindrical body.

### DETAILED DESCRIPTION OF PREFERRED EMBODIMENTS

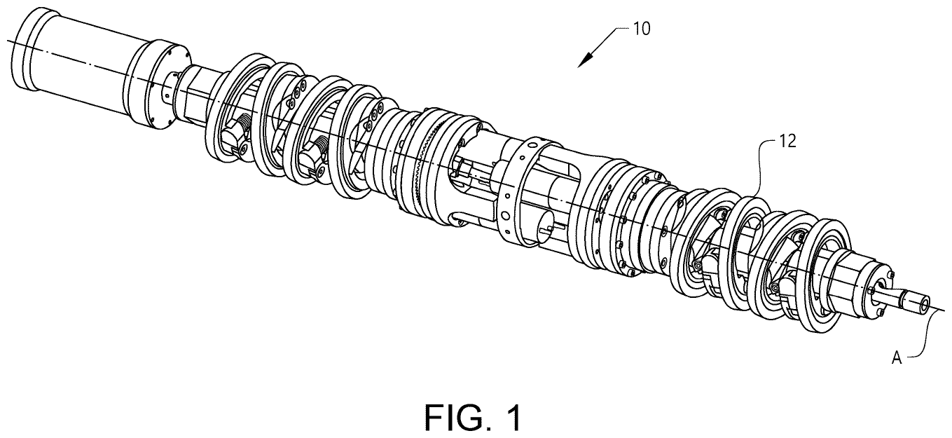

FIG. 1 illustrates a tractor 10 for propelling an apparatus inside a cylindrical body (not shown in FIG. 1). In the example illustrated in FIG. 1, the tractor 10 comprises a set of propulsion members 12, implemented as wheels in the FIG. 1 example. When the propulsion members 12 rotate around an axis of rotation A and the propulsion members 12 are in contact with an inner surface of the cylindrical body, a propulsion force in a direction parallel to the axis of rotation may be obtained. The propulsion force is obtained by virtue of the fact that each propulsion member 12 will undergo a helical motion relative to the cylindrical body, as explained in WO 2022/129328 A1.

In the following description, the term “cylindrical body” is used to describe any kind of body having an elongated extending opening, such as a pipeline, duct, channel, tube, drilled well with or without casing. Examples are flexible risers, umbilicals, oil or gas wells during or after drilling, oil or gas production pipelines, water pipes, waste pipes, process plant pipelines, geothermal wells, etc.

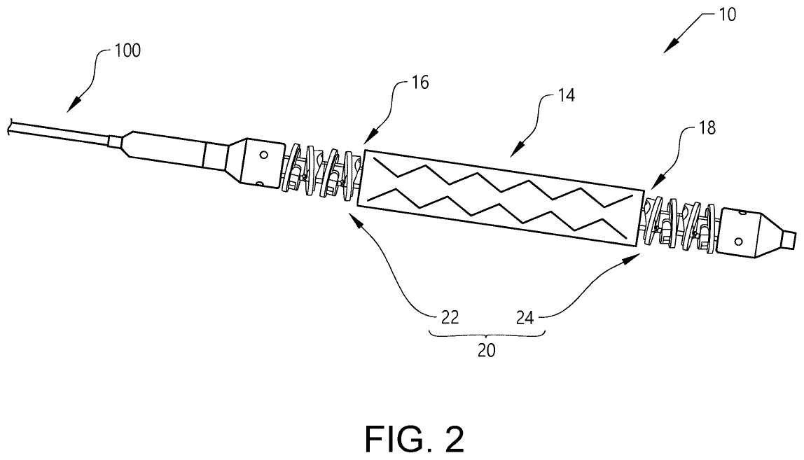

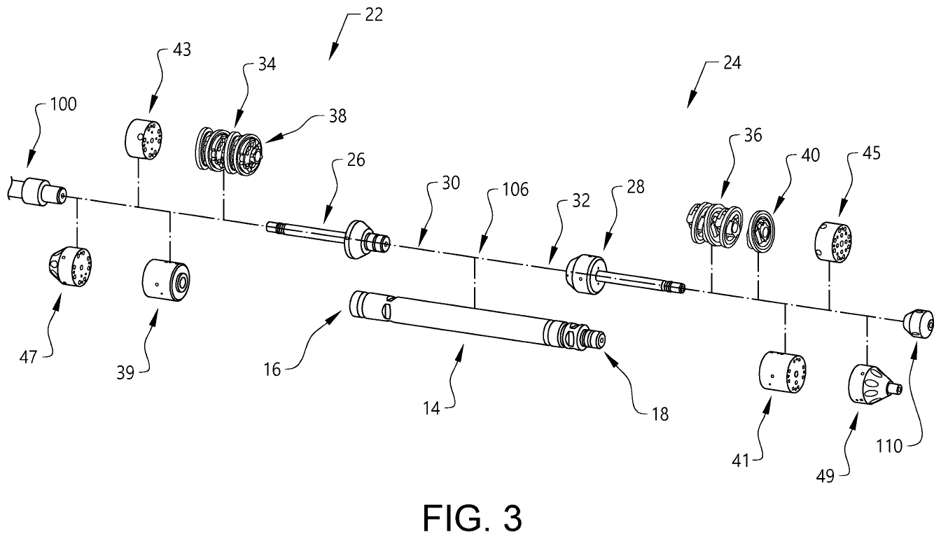

FIG. 2 and FIG. 3 illustrate an embodiment of a tractor 10 for propelling an apparatus inside a cylindrical body (not shown in FIG. 2). As indicated in FIG. 2, the tractor 10 comprises a fluid motor 14 comprising a fluid motor fluid inlet 16 and a fluid motor fluid exhaust 18. The tractor 10 further comprises a set of drive portions 20 comprising at least one drive portion. In the FIG. 2 example, the set of drive portions 20 comprises two drive portions 22, 24: a first drive portion 22 and a second drive portion 24. With reference to FIG. 3, each drive portion 22, 24 in the set of drive portions 20 comprises a drive shaft 26, 28 connected to the fluid motor 14 whereby the drive shaft 26, 28 is adapted to be rotated around an axis of rotation 30, 32 of the drive shaft 26, 28. Purely by way of example, in the FIG. 2 and FIG. 3 embodiment, the first drive portion 22 may be referred to as a rear drive portion and the second drive portion 24 may be referred to as a forward drive portion.

As a non-limiting example, the fluid motor may be powered by a gas, such as air. As another non-limiting example, the fluid motor may be powered by a liquid, such as oil or water.

Purely by way of example, and as indicated in FIG. 3 for instance, a drive shaft 26, 28 may be directly connected to the fluid motor 14. However, it is also envisaged that in embodiments of the tractor 10, at least one drive shaft 26, 28 may be indirectly connected to the fluid motor 14. As a non-limiting example, a drive shaft may be connected to the fluid motor 14 via a gear assembly (not shown) or the like. It is also envisaged that a first drive shaft may be connected to the fluid motor 14 via a second drive shaft, for instance using a gear assembly or the like.

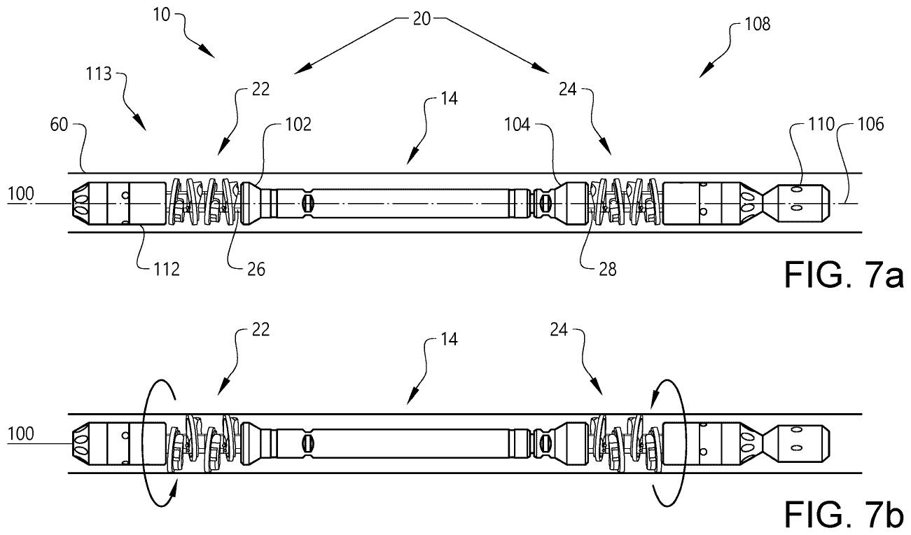

Moreover, as indicated in FIG. 3, each drive portion 22, 24 in the set of drive portions 20 comprises set of propulsion members 34, 36 comprising at least one propulsion member, preferably two or more propulsion members. Each propulsion member in the set of propulsion members 34, 36 is rotationally fixed to the drive shaft 26, 28. In the tractor 10 embodiment illustrated in FIG. 3, each one of the propulsion members 34, 36 comprises four individual propulsion members, each one of which being implemented as a wheel, as will be discussed further hereinbelow. A set of propulsion members 34, 36 comprising two or more propulsion members implies an increased possibility to keep the drive shaft 26, 28 radially in place relative to a cylindrical body 60 (see e.g. FIG. 7b hereinbelow) during propulsion of the tractor 10.

As such, using the first drive portion 22 in FIG. 3 as an example, when the drive shaft 26 of the first drive portion 22 rotates around the axis of rotation 30, each propulsion member in the set of propulsion members 34 rotates around the axis of rotation 30 of the drive shaft 26.

Moreover, each drive portion 22, 24 in said set of drive portions 20 comprises a fluid actuated control assembly 38, 40 adapted to control a largest distance, in a direction perpendicular to the axis of rotation 30, 32 of the drive shaft 26, 28, from the drive shaft 26, 28 to each propulsion member in the set of propulsion members 34, 36.

Additionally, the control assembly 38, 40 is adapted to be at least selectively in fluid communication with at least one of the fluid motor fluid inlet 16 and the fluid motor fluid exhaust 18.

FIG. 3 further illustrates, by way of example only, that the tractor 10 may comprise fluid interfaces 39, 41 and valve housings 43, 45 which may enable the selective fluid communication between a control assembly 38, 40 and one of the fluid motor fluid inlet 16 and the fluid motor fluid exhaust 18.

Moreover, though purely by way of example, the FIG. 3 embodiment comprises a fluid guide conduit interface 47 adapted to be connected to a fluid guide conduit 100. The fluid guide conduit 100 will be discussed further below. As a non-limiting example, the tractor 10 may comprise a further interface 49 for enabling a connection to a sensor 110 or a tool 110. As a non-limiting example, the tool may be a jetting nozzle, a fluid activated tool or the like.

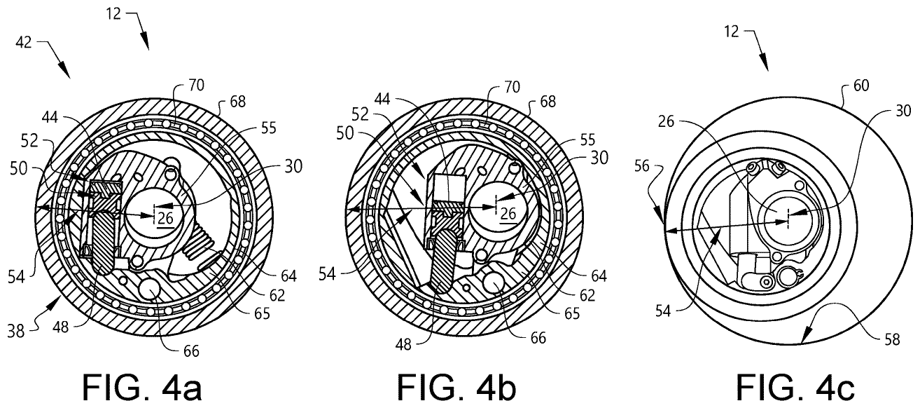

As regards the fluid actuated control assembly 38, reference is made to FIGS. 4a-4d illustrating a portion of an implementation of a fluid actuated control assembly 38. The implementation in FIGS. 4a-4d is exemplified using a portion of the fluid actuated control assembly 38 of the first drive portion 22 as an example. However, the FIGS. 4a-4d implementation could be used for any fluid actuated control assembly of the tractor 10.

As indicated in FIGS. 4a-4d , the control assembly 38 may comprise a set of fluid-controlled actuators 42, such that each propulsion member in the set of propulsion members is connected to an individual fluid-controlled actuator in the set of fluid-controlled actuators. FIGS. 4a-4d illustrate a single fluid-controlled actuator 44 that forms part of the set of fluid-controlled actuators 42 and which is adapted to control a single propulsion member 12 of the set of propulsion members 34 associated with the first drive portion 22.

However, it is also envisaged that other implementations of the fluid actuated control assembly 38, 40 may comprise a fluid-controlled actuator that is adapted to jointly control two or more propulsion members of a set of propulsion members 34.

In the implementation illustrated in FIGS. 4a-4d , the fluid-controlled actuator 44 comprises a fluid cylinder 48 with a piston 50 and a piston chamber 52.

Each fluid-controlled actuator 44 in the set of fluid-controlled actuators 42, wherein again a single fluid-controlled actuator 44 is used as an example in FIGS. 4a-4d , is adapted to increase the largest distance 54, in a direction perpendicular to the axis of rotation 30 of the drive shaft 26 (see FIG. 2), from the drive shaft 26 to an individual propulsion member 12 in the set of propulsion members 34, when pressure of fluid fed to the fluid-controlled actuator 44 is equal to or above a fluid control threshold pressure. To this end, though purely by way of example, the propulsion member 12 may comprise a hub 55 that is adapted to be connected to the drive shaft 26. Thus, the largest distance 54 may be associated with a distance from the centre of the hub 55 to a portion of the individual propulsion member 12.

To this end, reference is made to FIG. 4a and FIG. 4b. In FIG. 4a, the fluid-controlled actuator 44 is in a retracted condition in which the above-mentioned largest distance 54 is relatively small. However, in FIG. 4b, the fluid-controlled actuator 44 is in an expanded condition in which the largest distance 54 is larger than in the FIG. 4a condition. The condition of the fluid-controlled actuator 44 indicated in FIG. 4b has been obtained by feeding fluid to the piston chamber 52 to thereby expand the fluid-controlled actuator 44.

Purely by way of example, and as indicated in FIG. 4c, for at least one drive portion, preferably each drive portion, in the set of drive portions, each propulsion member 12 in the set of propulsion members comprises a propulsion member contact portion 56 adapted to contact an inner surface 58 of a cylindrical body 60 within which the tractor is operating. The largest distance 54 from the drive shaft 26 to the propulsion member 12 constitutes the distance from the drive shaft 26 to the propulsion member contact portion 56 in the direction perpendicular to the axis of rotation 30 of the drive shaft 26. This is illustrated in FIG. 4c using a single propulsion member 12.

As such, when the largest distance 54 is relatively small, such as in the FIG. 4a condition, there may be no contact between the propulsion member 12 and the inner surface 58 of the cylindrical body 60 (the cylindrical body 60 is illustrated in FIG. 4c). Consequently, even when the propulsion member 12 rotates around the axis of rotation 30, such a rotation will not create a propulsion force between the tractor 10 and the cylindrical body 60.

However, when the largest distance 54 is relatively large, such as in the FIGS. 4b and 4c conditions, contact is established between the propulsion member 12 and the inner surface 58 of the cylindrical body 60. As such, when the propulsion member 12 rotates around the axis of rotation 30, such a rotation creates a propulsion force between the tractor 10 and the cylindrical body 60.

In other words, the fluid-controlled actuator 44 in the FIGS. 4a-4d implementation can be used for controlling whether or not there should be contact between the propulsion member 12 and the inner surface 58 of the cylindrical body 60.

Moreover, though purely by way of example, FIGS. 4a-4d illustrate that the control assembly may comprise a biasing arrangement 62 adapted to bias each propulsion member 12 in the set of propulsion members 34 towards a position with a minimum largest distance 54, in a direction perpendicular to the axis of rotation 30 of the drive shaft 26, from the drive shaft 26 to the propulsion member 12. In the FIGS. 4a-4d implementation, the biasing arrangement 62 is exemplified by a single biasing member, such as a spring, adapted to bias a single propulsion member 12 in the set of propulsion members 34 towards a position with a minimum largest distance 54, in a direction perpendicular to the axis of rotation 30 of the drive shaft 26, from the drive shaft 26 to the propulsion member 12. However, in other implementations of the control assembly, the biasing arrangement 62 may comprise one or more biasing members adapted to bias two or more propulsion members towards positions in which each propulsion member has a minimum largest distance 54.

Moreover, as indicated in FIGS. 4a-4d, for at least one drive portion, preferably each drive portion, in the set of drive portions, each propulsion member 12 in the set of propulsion members comprises a rim 64 enclosing the drive shaft 26. Preferably each propulsion member in the set of propulsion members comprises a wheel 65 that in turn comprises the rim 64. Purely by way of example, and as indicated in FIGS. 4a and 4b, the rim 64 may be pivotally connected to the hub 55 via a pivotal connection point 66 which for instance may comprise a rotary bolt. Moreover, as indicated in FIG. 4a for instance, the propulsion member 12 may comprise a friction member 68 circumferentially enclosing the rim 64. Purely by way of example, the friction member 68 may be referred to as a tyre. As a non-limiting example, a bearing 70 may be located between the rim 64 and the friction member 68.

As such, though purely by way of example, when the pressure increases in the piston chamber 52, the piston 50 will be pushed along the piston chamber 52 whereby the rim 64 will rotate about the pivotal connection point 66 such that the hub 55 and the rim 64 will become eccentric, as illustrated in FIGS. 4b and 4c, respectively. The friction member 68 will push against the inner surface 58 of the cylindrical body 60, as illustrated in FIG. 4c, and create a friction connection at the friction member contact portion 56. The bearing 70 allows the friction member 68 to rotate freely on the rim 64.

As may be realized from the above, each propulsion member 12 of a set of propulsion members comprises one of the rims 64. The control assembly may be adapted to control the eccentricity of the rim 64 of each propulsion member relative to the drive shaft 26 to thereby control the largest distance 54, in a direction perpendicular to the axis of rotation 30 of the drive shaft 26, from the drive shaft 26 to each propulsion member 12 in the set of propulsion members.

As indicated above, FIG. 4c illustrates a propulsion member 12 with its rim 64 in an eccentric condition such that the propulsion member contact portion 56 of the friction member 68 is in contact with the inner surface 58 of the cylindrical body 60. As such, the rim 64 will impart a force on a portion of the friction member 68 which will contact the inner surface 58 of the cylindrical body 60.

When the drive shaft 26 rotates around its axis of rotation 30, the rim 64 will rotate with the drive shaft 26. Due to the bearing 70 between the rim 64 and the friction member 68, the rim 64 will subsequently impart a force on another portion (adjacent to the previous portion) of the friction member 68 which will then contact the inner surface 58 of the cylindrical body 60. As such, the rotation of the drive shaft 26 and thus the rim 64 will result in that the contact point between the friction member 68 and the inner surface 58 of the cylindrical body 60 will propagate along the circumference of the friction member 68. Due to the fact that the propulsion member 12 is tilted relative to the drive shaft, as will be elaborated on hereinbelow, the above propagation of the contact point will result in a frictional force which may be substantially parallel to the axis of rotation 30 such that propulsion force being substantially parallel to the axis of rotation 30 is obtained. Moreover, the tilted propulsion member 12 and the propagating contact force as presented above will result in that the contact between the friction member 68 and the inner surface 58 of the cylindrical body 60 will form a helical path along the inner surface 58.

To this end, FIG. 4d illustrates a side view of a propulsion member 12. As illustrated in FIG. 4d, the propulsion member 12 may be tilted relative to the drive shaft 26. Thus, as indicated in FIG. 4d, the rim 64 may extend in a rim plane 71 (see FIG. 4d) and the rim plane 71 may form a rim angle β with the axis of rotation 30 of the drive shaft 26. As may be realized from FIG. 4d, the rim plane 71 may actually form two angles with the axis of rotation 30, a first angle from the rim plane 71 to the axis of rotation 30 to the right of the rim plane 71 and a second angle from the rim plane 71 to the axis of rotation 30 to the left of the rim plane 71. As used herein, and as indicated in FIG. 4d, the rim angle β relates to the smallest angle from the rim plane 71 to the axis of rotation 30 of the drive shaft 26. As indicated in FIG. 4 d, the rim angle β is less than 90° such that the propulsion member 12 may be regarded as tilted relative to the drive shaft 26. Purely by way of example, the rim angle β may be less than 88°, preferably less than 85°.

As other non-limiting examples, the rim angle β may be greater than 45°, preferably greater than 65°, more preferred greater than 75°.

As a non-limiting example, the tractor 10 may be such that the rim angle β can be adjusted for each propulsion member 12. As a non-limiting option, the tractor may comprise one or more adjustable members (not shown), such as bolts or the like, by which it is possible to set the rim angle B. As another non-limiting alternative, the fluid actuated control assembly 38 may also have the capability to adjust the rim angle β for each propulsion member 12.

The above features with the rim plane 71 and the rim angle β may apply for every propulsion member 12.

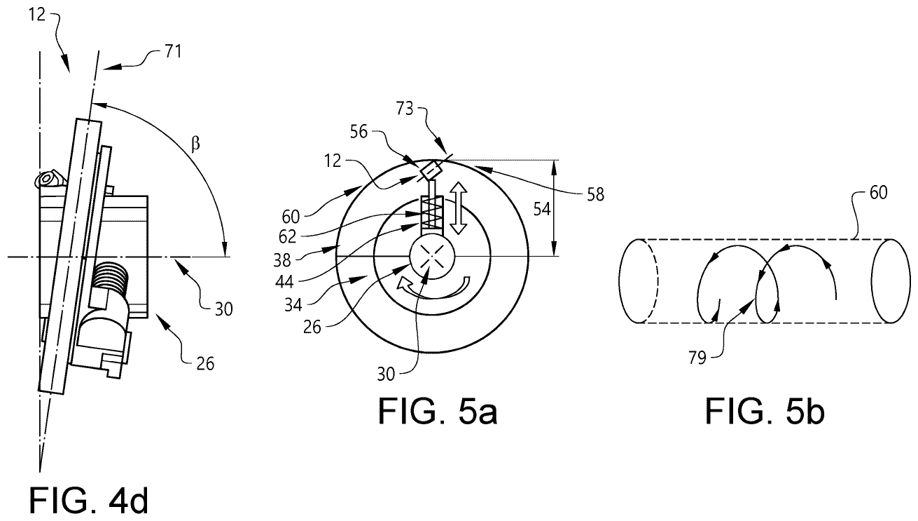

It should be noted that the fluid actuated control assembly 38 may be implemented in a plurality of ways instead of, or in addition to, the implementation presented above with reference to FIGS. 4a-4d. To this end, though purely by way of example, reference is made to FIG. 5a illustrating a portion of another implementation of the fluid actuated control assembly 38.

FIG. 5a illustrates an example with a set of propulsion members 34 on which a single propulsion member 12 of the set of propulsion members 34 associated with the first drive portion 22 is illustrated for the sake of clarity. In the FIG. 5a example, the propulsion member 12 is implemented as a roll that is adapted to be rotated around the axis of rotation 30 of the drive shaft 26 of the first drive portion 22. Moreover, as indicated in FIG. 5a, a fluid-controlled actuator 44 may control the largest distance 54, in a direction perpendicular to the axis of rotation 30 of the drive shaft 26, from the drive shaft 26 to the individual propulsion member 12. In FIG. 5a, the fluid-controlled actuator 44 is implemented as a fluid cylinder. As indicated by the double arrow in FIG. 5a, the largest distance 54 may be altered by actuating the fluid-controlled actuator 44.

Moreover, though purely by way of example, FIG. 5a illustrates that the control assembly may comprise a biasing arrangement 62 adapted to bias each propulsion member 12 in the set of propulsion members 42 towards a position with a minimum largest distance 54, in a direction perpendicular to the axis of rotation 30 of the drive shaft 26, from the drive shaft 26 to the propulsion member 12. In the FIG. 5a implementation, the biasing arrangement 62 is exemplified by a single biasing member, such as a spring, adapted to bias a single propulsion member 12 in the set of propulsion members 42 towards a position with a minimum largest distance 54, in a direction perpendicular to the axis of rotation 30 of the drive shaft 26, from the drive shaft 26 to the propulsion member 12.

The largest distance 54 from the drive shaft 26 to the propulsion member 12 is the distance from the drive shaft 26 to the propulsion member contact portion 56 in the direction perpendicular to the axis of rotation 30 of the drive shaft 26.

Purely by way of example, the propulsion member contact portion 56 in FIG. 5a may comprise a roll that is adapted to rotate around a roll axis of rotation 73, wherein the roll axis of rotation 73 forms an angle with the axis of rotation 30 of the drive shaft 26 which is in the range of 30-80°. Alternatively, the fluid-controlled actuator 44 or any other connector connecting the drive shaft 26 to the propulsion member 12 in FIG. 5a may be tilted relative to the drive shaft 26 in a similar way as presented hereinabove with reference to FIG. 4d. Thereby, a rotation of the drive shaft 26 around the axis of rotation 30 will result in a propulsion force in a manner similar to the one that has been presented hereinabove with reference to FIG. 4c and FIG. 4d.

As may be realized from the FIGS. 4a-4d and FIG. 5a implementations, a fluid actuated control assembly 38, 40 forming part of a drive portion 22, 24 may be implemented in a plurality of different ways.

However, irrespective of the actual implementation of the fluid actuated control assembly 38, 40, the fluid actuated control assembly 38, 40 is adapted to control a largest distance 54, in a direction perpendicular to the axis of rotation 30, 32 of the drive shaft 26, 28, from the drive shaft 26, 28 to each propulsion member in the set of propulsion members 34, 36.

Furthermore, purely by way of example and as indicated in each one of the FIGS. 4a-4d and FIG. 5a implementations, for at least one drive portion 22, preferably each drive portion, in the set of drive portions 20, each propulsion member 12 in the set of propulsion members 34 is adapted to transfer a force from an inner surface 58 of the cylindrical body 60 to the drive shaft 26 when the largest distance 54 is equal to or above a largest distance threshold. As a non-limiting example, a contact between a propulsion member 12 and the inner surface 58 of the cylindrical body 60 may result in that a resulting force, for instance comprising a contact force component and frictional force component, is imparted on the propulsion member 12 and transferred to the drive shaft 26.

As may be realized from the above, by way of example only, the largest distance threshold may be dependent on the diameter of the cylindrical body 60.

Additionally, purely by way of example and as also indicated in each one of the FIG. 4a-4d and FIG. 5a implementations, for at least one drive portion 22, preferably each drive portion, in the set of drive portions 20, each propulsion member 12 in the set of propulsion members 34 is such that when the drive shaft 26 rotates around the axis of rotation 30 and the propulsion member 12 transfers a force from the inner surface 58 of the cylindrical body 60 to the drive shaft 26, a propulsion force is imparted on the tractor 10.

Here, it should also be noted that, by way of example only, for at least one drive portion 22, preferably each drive portion, in the set of drive portions 20, each propulsion member 12 in the set of propulsion members 34 is such that when the drive shaft 26 rotates around the axis of rotation 30 and the propulsion member 12 transfers a force from the inner surface 58 of the cylindrical body 60 to the drive shaft 26, a contact point between the propulsion member 12 and the inner surface 58 of the cylindrical body 60 will vary as the drive shaft 26 rotates around the axis of rotation 30 such that a trajectory 79 of subsequent contact points will form a helical shape on the inner surface 58 of the cylindrical body 60. Such a helical shape is indicated in FIG. 5b. It should be noted that the helical shape indicated in FIG. 5b may be obtained for a plurality of different implementations of the propulsion member 12, such as any one of the implementations presented hereinabove with reference to FIGS. 4a-4d and FIG. 5a.

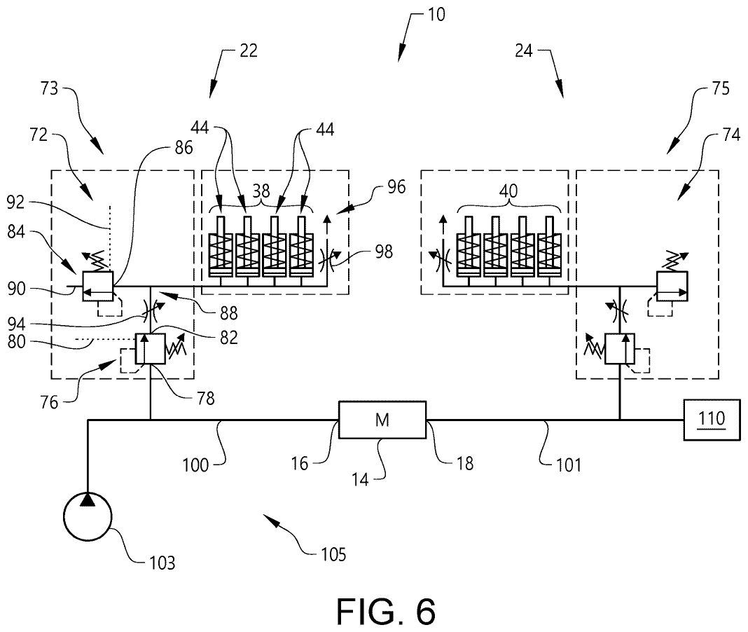

FIG. 6 is a schematic view of a fluid system for a tractor 10. The tractor 10 comprises a fluid motor 14 comprising a fluid motor fluid inlet 16 and a fluid motor fluid exhaust 18. The tractor 10 further comprises a set of drive portions 20 (see FIG. 2 above) comprising at least one drive portion. The FIG. 6 set of drive portions 20 comprises two drive portions, a first drive portion 22 and a second drive portion 24.

As indicated above with reference to FIG. 3, each drive portion 22, 24 in the set of drive portions 20 comprises a drive shaft 26, 28 connected to the fluid motor 14 whereby the drive shaft 26, 28 is adapted to be rotated around an axis of rotation 30, 32 of the drive shaft 26, 28. Moreover, as also indicated in FIG. 3, the each drive portion 22, 24 in the set of drive portions 20 comprises a set of propulsion members 34, 36 comprising at least one propulsion member, preferably two or more propulsion members. Each propulsion member in the set of propulsion members 34, 36 is rotationally fixed to the drive shaft 26, 28.

Furthermore, as indicated in FIG. 6, each one of the drive portions 22, 24 in the set of drive portions 20 comprises a fluid actuated control assembly 38, 40 adapted to control the above-mentioned largest distance 54. Implementations of the fluid actuated control assembly 38, 40 have been presented hereinabove with reference to e.g. FIGS. 4a-4c and FIG. 5a and are consequently not repeated here.

Moreover, as also indicated in FIG. 6, the control assembly 38, 40 is adapted to be at least selectively in fluid communication with at least one of the fluid motor fluid inlet 16 and the fluid motor fluid exhaust 18.

In particular, in the FIG. 6 embodiment, the control assembly 38, 40 of one of the first drive portion 22 and a second drive portion 24 is adapted to be at least selectively in fluid communication with the fluid motor fluid inlet 16 and the control assembly 38, 40 of the other one of the first drive portion 22 and a second drive portion 24 is adapted to be at least selectively in fluid communication with the fluid motor fluid exhaust 18.

In the FIG. 6 example, the control assembly 38, 40 of each one of the first drive portion 22 and a second drive portion 24 comprises a plurality of cylinders, for instance one for each propulsion member (not shown in FIG. 6) in the set of propulsion members forming part of each one of the first and second drive portions 22, 24. However, it is also envisaged that in other embodiments, each control assembly may comprise a single actuator (not shown), such as a cylinder, for controlling the above-mentioned largest distance from the drive shaft to a plurality of propulsion members, for instance each propulsion member, in the set of propulsion members.

In the FIG. 6 embodiment, the control assembly 38 of one of the first drive portion 22 is adapted to be at least selectively in fluid communication with the fluid motor fluid inlet 16 and the control assembly 40 of the second drive portion 24 is adapted to be at least selectively in fluid communication with the fluid motor fluid exhaust 18.

Furthermore, as indicated in the FIG. 6 embodiment, at least one drive portion, preferably each drive portion, in the set of drive portions comprises a fluid flow control assembly adapted to control a flow of fluid from one of the fluid motor fluid inlet and the fluid motor fluid exhaust to the control assembly 38. In the FIG. 6 embodiment, the first drive portion 22 comprises a fluid flow control assembly 72 adapted to control a flow of from fluid the fluid motor fluid inlet 16 to the control assembly 38 of the first drive portion 22. Moreover, in the FIG. 6 embodiment, the second drive portion 24 comprises a fluid flow control assembly 74 adapted to control a flow of fluid from the fluid motor fluid exhaust 18 to the control assembly 40 of the second drive portion 24.

Features of the fluid flow control assembly will be presented hereinbelow with reference to the fluid flow control assembly 72 of the first drive portion 22. However, it should be noted that the features of fluid flow control assembly 72 are applicable to a fluid control assembly of any drive portion.

As indicated by way of example in FIG. 6, the fluid flow control assembly 72 may comprise an inlet pressure relief valve 76 comprising an inlet pressure relief valve inlet 78 being in fluid communication with one of the fluid motor fluid inlet 16 and the fluid motor fluid exhaust 18. In the FIG. 6 embodiment, the inlet pressure relief valve inlet 78 is in fluid communication with the fluid motor fluid inlet 16.

The inlet pressure relief valve 76 is adapted to allow fluid passage via the inlet pressure relief valve 76 when a fluid pressure acting on the inlet pressure relief valve inlet 78 is equal to or exceeds a threshold inlet pressure and to prevent fluid passage via the inlet pressure relief valve when the fluid pressure acting on the inlet pressure relief valve inlet is lower than the threshold inlet pressure. As a non-limiting example, the threshold inlet pressure may be in the range of 150-300 bar.

As such, actuation of the control assembly 38 may be achieved by ensuring that the pressure of the fluid fed to the inlet pressure relief valve inlet 78 is equal to or above the threshold inlet pressure. Consequently, rather than using a separate signal for actuation of the control assembly 38, the pressure of the fluid fed to the fluid motor fluid inlet 16 (or from the fluid motor fluid exhaust 18) may be used for controlling the actuation of the control assembly 38. This implies that characteristics of the tractor 10 may be controlled by appropriate pressure levels of the fluid fed to the fluid motor and this in turn implies that the propulsion of the tractor 10 may be controlled in a straightforward manner.

As a non-limiting example, the inlet pressure relief valve 76 may be adapted to receive a threshold inlet pressure signal 80, indicative of a requested threshold inlet pressure, and to set the threshold inlet pressure on the basis of the threshold inlet pressure signal. As such, the inlet pressure relief valve 76 may comprise a receiver (not shown) for receiving a signal from a transmitter (not shown). Purely by way of example, the transmitter and the receiver may communicate via a wire or by wireless technology.

It is also envisaged that the threshold inlet pressure may be fixed. As another non-limiting example, the threshold inlet pressure may be adjustable by an adjusting member (not shown), such as a knob, lever or the like connected to the inlet pressure relief valve 76.

Moreover, again with reference to FIG. 6, though purely by way of example, the inlet pressure relief valve 76 may comprise an inlet pressure relief valve outlet 82. Moreover, the fluid flow control assembly 72 may comprise an outlet pressure relief valve 84 comprising an outlet pressure relief valve inlet 86 being in fluid communication with the inlet pressure relief valve outlet 82. As a non-limiting example, and as indicated in FIG. 6, the outlet pressure relief valve inlet 86 may be in fluid communication with the inlet pressure relief valve outlet 82 via a conduit assembly 88 comprising one or more conduits.

The outlet pressure relief valve 84 is adapted to allow fluid passage via the outlet pressure relief valve 84 when a fluid pressure acting on the outlet pressure relief valve inlet 86 is equal to or exceeds a threshold outlet pressure and to prevent fluid passage via the outlet pressure relief valve when the fluid pressure acting on the outlet pressure relief valve inlet is lower than the threshold outlet pressure. Preferably, the threshold outlet pressure is lower than the threshold inlet pressure and this may apply for any implementation of the fluid flow control assembly 72. As a non-limiting example, the threshold outlet pressure may be in the range of 50 -150 bar.

The outlet pressure relief valve 84 may be used for ensuring that fluid reaching the control assembly 38 does not have too high pressure.

Moreover, again purely by way of example, as indicated in FIG. 6, the outlet pressure relief valve 84 may comprise an outlet pressure relief valve outlet 90 being in fluid communication with the environment ambient of the tractor 10.

Further, as indicated by way of example in FIG. 6, the outlet pressure relief valve 84 may be adapted to receive a threshold outlet pressure signal 92, indicative of a requested threshold outlet pressure, and to set the threshold outlet pressure on the basis of the threshold outlet pressure signal. As such, the outlet pressure relief valve 84 may comprise a receiver (not shown) for receiving a signal from a transmitter (not shown). Purely by way of example, the transmitter and the receiver may communicate via a wire or by wireless technology.

It is also envisaged that the threshold outlet pressure may be fixed. As another non-limiting example, the threshold outlet pressure may be adjustable by an adjusting member (not shown), such as a knob, lever or the like connected to the outlet pressure relief valve 84.

The fluid flow control assembly 72 may comprise an internal throttling 94 adapted to throttle a fluid flow from the inlet pressure relief valve outlet 82 to the outlet pressure relief valve inlet 86. Preferably the internal throttling 94 may be an adjustable internal throttling. As non-limiting examples, the internal throttling 94 may comprise one or more of the following: an adjustable choke valve (not shown), one or more blind plugs in some of the flow ports of the internal throttling (not shown) and nozzles in flow ports of the internal throttling (not shown).

As also illustrated in FIG. 6 by way of example, the fluid flow control assembly 72 may comprise a fluid flow control assembly exhaust 96 downstream the control assembly 38, as seen in a direction of flow to the control assembly 38 from one of the fluid motor fluid inlet 16 and the fluid motor fluid exhaust 18. For the first drive portion 22 used as an example in FIG. 6, the fluid flow control assembly exhaust 96 is located downstream the control assembly 38, as seen in a direction of flow to the control assembly 38 from the fluid motor fluid inlet 16. The fluid flow control assembly exhaust 96 is adapted to discharge fluid to the environment ambient of the tractor 10.

By way of example and as indicated in FIG. 6, the inlet pressure relief valve 76 may comprise an inlet pressure relief valve outlet 82 which is in constant fluid communication with the fluid flow control assembly exhaust 96. Put differently, there is no diverting valve, selection valve or the like between the inlet pressure relief valve outlet 82 and the fluid flow control assembly exhaust 96.

Moreover, as indicated in FIG. 6 by way of example, the fluid flow control assembly exhaust 96 may comprise an exhaust throttling 98 adapted to throttle the fluid discharged to the environment ambient of the tractor 98. As a non-limiting example, the fluid flow control assembly 72 may comprise a backpressure valve (not shown) downstream the exhaust throttling 98 in order to prevent fluid ambient of the tractor 10 from flowing towards the control assembly 38 via the fluid flow control assembly exhaust 96. As another non-limiting example, the fluid flow control assembly 72 may comprise a filter (not shown) downstream the exhaust throttling 98 in order to prevent debris or other types of pollution from reaching the control assembly 38 via the fluid flow control assembly exhaust 96.

Furthermore, and as indicated in the FIG. 6 example, the tractor 10 may comprise a fluid guide conduit 100 adapted to guide fluid to the fluid motor fluid inlet 16. Moreover, as indicated in FIG. 6, the inlet pressure relief valve inlet 78 may be in fluid communication with the fluid guide conduit 100. As such, a portion of the fluid fed to the fluid motor fluid inlet 16 may be bled to the control assembly 38 via the inlet pressure relief valve inlet 78. As a non-limiting example, the fluid guide conduit 100 may be adapted to be connected to a source of pressurized fluid 103, such as a pump. The tractor 10 and the source of pressurized fluid 103 may form a tractor assembly 105, as indicted in FIG. 6.

Furthermore, as also exemplified in FIG. 6, the tractor 10 may comprise an exhaust fluid guide conduit 101 adapted to guide fluid from the fluid motor fluid exhaust 18. As a non-limiting example, the exhaust fluid guide conduit 101 may be adapted to discharge fluid to the environment ambient of the tractor 10. However, it is also envisaged that in embodiments of the tractor, the exhaust fluid guide conduit 101 may be adapted to return fluid to a tank (not shown) or the like such that the fluid may be recycled. As another non-limiting option, and as indicated in FIG. 6, the exhaust fluid guide conduit 101 may be adapted to be connected to a tool 110, such as a jetting nozzle or a fluid activated tool.

Moreover, as indicated in e.g. FIG. 6, a portion of the tractor 10 that is adapted to bleed fluid from the fluid guide conduit 100 to the control assembly 38 of the first drive portion 22 may be referred to as pressure diversion unit 73. In a similar vein, again with reference to FIG. 6, a portion of the tractor 10 that is adapted to bleed fluid from the exhaust fluid guide conduit 101 to the control assembly 40 of the second drive portion 24 may also be referred to as a second pressure diversion unit 75.

As indicated in FIG. 6, the control assembly 38 may comprise a set of fluid-controlled actuators 44. Each fluid-controlled actuator 44 controls an individual propulsion member in the set of propulsion members, see e.g. FIGS. 3 and 4. Moreover, as indicated in FIG. 6, the fluid-controlled actuators 44 forming part of the control assembly 38 are connected to the conduit assembly 88 between the outlet pressure relief valve inlet 86 and the fluid flow control assembly exhaust 96. This implies that if any individual propulsion member encounters an obstacle, such as debris or the like, during propulsion of the tractor 10, the individual propulsion member and its associated fluid-controlled actuator 44 may be allowed to be retracted somewhat against the pressure in the conduit assembly 88 to accommodate for the obstacle.

Moreover, as indicated in FIG. 6, the conduit assembly 88 extending from the pressure relief valve outlet 82 to the fluid flow control assembly exhaust 96 may be physically separate from each of the fluid guide conduit 100 and the exhaust fluid guide conduit 101.

Reference is now made to FIG. 7a illustrating an embodiment of the tractor 10. As may be gleaned from FIG. 7a, the embodiment of the tractor illustrated therein comprises set of drive portions 20 which comprises at least two drive portions 22, 24, namely a first drive portion 22 and a second drive portion 24.

Purely by way of example, and as indicated in FIG. 7a, the fluid motor 14 may comprise a stator 102 and a rotor 104. When the fluid motor 14 is operating so as to produce a torque and a rotational speed, the rotor 104 rotates relative to the stator 102. As exemplified in FIG. 7a, the drive shaft 26, 28 of one of the first drive portion 22 and the second drive portion 24 is rotationally connected to the stator 102 and the drive shaft 26, 28 of the other one of the first drive portion 22 and the second drive portion 24 is rotationally connected to the rotor 104. In the example illustrated in FIG. 7a, the drive shaft 26 of the first drive portion 22 is rotationally connected to the stator 102 and the drive shaft 28 of the second drive portion 24 is rotationally connected to the rotor 104. However, it is of course also envisaged that in other embodiments of the tractor 10, the drive shaft 26 of the first drive portion 22 may be rotationally connected to the rotor 104 and the drive shaft 28 of the second drive portion 24 may be rotationally connected to the stator 102.

The connections indicated above imply that the first drive portion 22 and the second drive portion 24 may have similar rotational speeds but in opposite directions during operation of the fluid motor 14. Such a condition is indicated in FIG. 7b. Moreover, as may be realized when comparing FIG. 7a and FIG. 7b, in FIG. 7b, fluid actuated control assemblies (not shown in FIG. 7a and FIG. 7b) have been actuated so as to increase the largest distance from the drive shaft 26, 28 to each propulsion member in said set of propulsion members 22, 24.

When the propulsion members rotate in the manner indicated in FIG. 7b, the tractor 10 may be less prone to being rotated, e.g. rotated around an axis extending in a longitudinal direction 106 of the tractor 10, during use and such a characteristic may be achieved by a relatively low number of components since the first and second drive portions 22, 24 are connected to the stator 102 and the rotor 104, respectively.

Put differently, each propulsion member in the set of propulsion members of the first drive portion 22 is adapted to rotate in a rotational direction opposite to the rotational direction of each propulsion member in the set of propulsion members of the second drive portion 24. Again, rotations in opposite directions imply that the first and second drive portions 22, 24 together do not produce a large torque that will rotate the tractor 10 or any portion of the apparatus relative to the cylindrical body 60.

For the sake of completeness, it should be noted that the rotation in different directions may be obtained in other ways than connecting the first and second drive portions 22, 24 to each one of the stator 102 and the rotor 104, respectively. Purely by way of example, both the first and second drive portions 22, 24 may be connected the same entity of the fluid motor 14, such as the stator 102 or the rotor 104, and the different rotational directions may be achieved by connecting together the drive shafts 26, 28 of the first and second drive portions 22, 24 using a gear assembly (not shown) or the like which rotationally connects the drive shafts 26, 28 such that a rotation in a rotational direction of one of the drive shafts 26 results in a rotation in the other direction of the other drive shaft 28.

Moreover, as further indicated in FIG. 7a, the tractor 10 extends along a longitudinal extension in the longitudinal direction 106. The set of propulsion members of the first drive portion 22 and the set of propulsion members of the second drive portion 24 are located on opposite sides of the fluid motor 14 in the longitudinal direction 106. In fact, in the FIG. 7a embodiment, the first drive portion 22 and the second drive portion 24 are located on opposite sides of the fluid motor 14 in the longitudinal direction 106. To this end, reference is also made to FIG. 3 illustrating an embodiment in which the first drive portion 22 and the second drive portion 24 are located on opposite sides of the fluid motor 14 in the longitudinal direction 106.

Purely by way of example, the axis of rotation 30 of the drive shaft 26 of the first drive portion 22 and the axis of rotation 32 of the drive shaft 28 of the second drive portion 24 form an angle having an absolute value being less than 10°. Preferably, and as illustrated in FIG. 7a, the axis of rotation 30 of the drive shaft 26 of the first drive portion 22 is parallel to and coaxial with the axis of rotation 32 of the drive shaft 28 of the second drive portion 24. To this end, reference is again also made to FIG. 3 illustrating an embodiment in which the axis of rotation 30 of the drive shaft 26 of the first drive portion 22 is parallel to the axis of rotation 32 of the drive shaft 28 of the second drive portion 24.

FIG. 7a also indicates an embodiment of the second aspect of the present disclosure, namely an apparatus 108 comprising the tractor 10 according to the first aspect of the present disclosure. Moreover, as indicated in FIG. 7a, the apparatus 108 may further comprise a sensor and/or a tool. In the FIG. 7a embodiment, the apparatus 108 comprises a sensor 110 which for instance could be a sensor for measuring at least one of the following: temperature, fluid flow, torque, pressure and humidity. It is also envisaged that instead of, or in addition to, a sensor 110, embodiments of the apparatus may comprise a tool 110, such as a drilling tool, welding tool or the like. The sensor 110 and/or tool 110 may be fixedly or releasably connected to the tractor 10. Purely by way of example, the sensor 110 and/or tool may be connected to the tractor 10 by means of a bolt joint.

As indicated in FIG. 7a by way of example, the cylindrical body 60 has a longitudinal extension in a longitudinal cylindrical body direction 112. Moreover, as indicated in FIG. 7a, the tractor 10 is adapted to propel the apparatus 108 in a direction parallel to and/or coaxial with the longitudinal cylindrical body direction.

Furthermore, as presented in FIG. 7a as a non-limiting example, for at least one drive portion 22, 24, preferably each drive portion, in the set of drive portions 20, when in use, the axis of rotation of the drive shaft 26, 28 and the longitudinal cylindrical body direction 112 form an angle having an absolute value being less than 10°. Preferably, and as exemplified in FIG. 7a, the axis of rotation of the drive shaft, preferably each drive shaft 26, 28, is parallel to the longitudinal cylindrical body direction 112.

Additionally, as indicated in FIG. 7a for instance, the cylindrical body 60 and the tractor 10 may form a cylindrical body assembly 113.

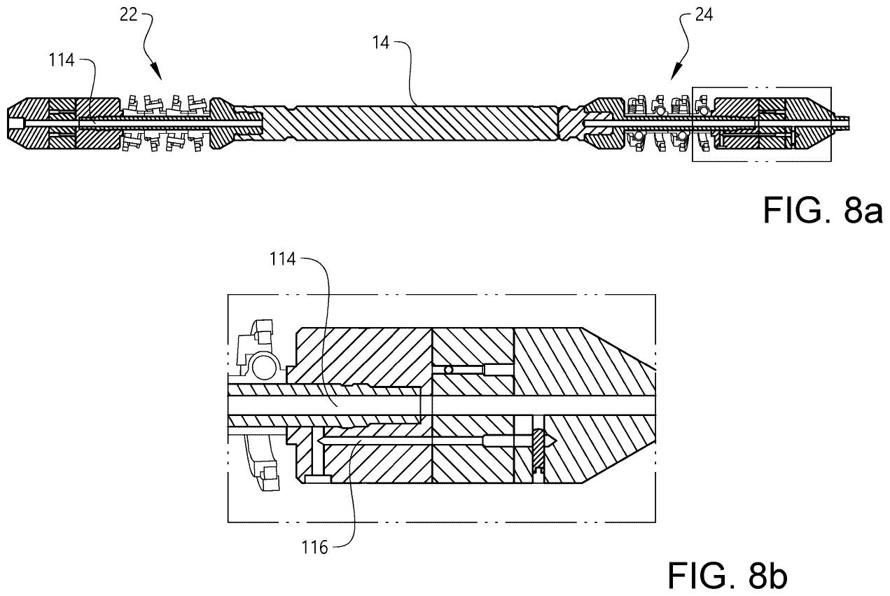

FIGS. 8a and 8b illustrate sectional views of a fluid flow line, such as a hydraulic fluid flow line, of a tractor 10. In FIG. 8b, a cut sectional view exposes inner fluid cavity 114 or channel through components of the tractor 10 such as the first drive portion 22, the fluid motor 14 and the second drive portion 24. The fluid cavity/channel 114 carries fluid, such as hydraulic fluid, for supply to the fluid motor 14 and the first and second drive portions 22, 24.

In FIG. 8b, it can be seen a side cavity or channel 116 that branches from the main channel 114. The side channel 116 supplies working fluid to the control assembly 40 of the second drive portion 24.

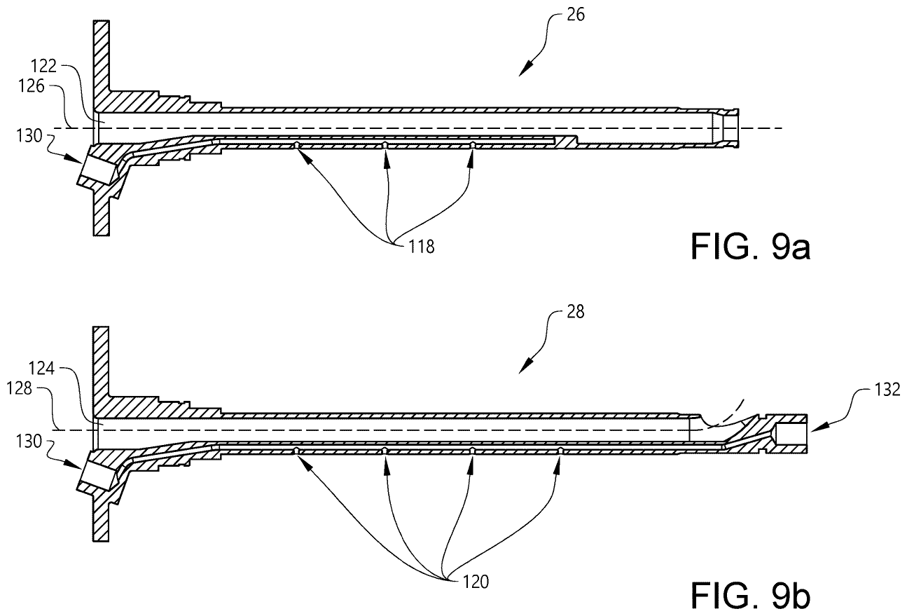

FIGS. 9a and 9b illustrate a sectional view of embodiments of the drive shaft 26, 28 of a first and second drive portion 22, 24, such as the first and second drive portions 22, 24 presented hereinabove with reference to FIG. 3 and/or FIG. 7a and FIG. 7b. In FIGS. 9a and 9b, each drive shaft 26, 28 comprises openings 118, 120 for supplying working fluid to the fluid actuated control assembly of the respective one of the first and second drive portion 22, 24. As indicated in e.g. FIG. 9a, the drive shaft 26 may comprise an opening 118 for every fluid-controlled actuator (not shown in FIG. 9a) of the fluid actuated control assembly 38 associated with the drive shaft 26. In a similar vein, and as indicated in e.g. FIG. 9b, the FIG. 9b drive shaft 28 may comprise an opening 120 for every fluid-controlled actuator (not shown in FIG. 9a) of the fluid actuated control assembly 40 associated with the drive shaft 28.

Each one of the drive shafts 26, 28 exemplified in FIGS. 9a and 9b may also have a central shaft cavity 122, 124 for supplying the fluid to or from a hydraulic motor (not shown in FIGS. 9a and 9b). In addition, the drive shafts 26, 28 may also comprise additional signal and/or power cables 126, 128. The fluid cavity of the shaft may also provide connections 130, 132 for connection to hoses or other hydraulic equipment.

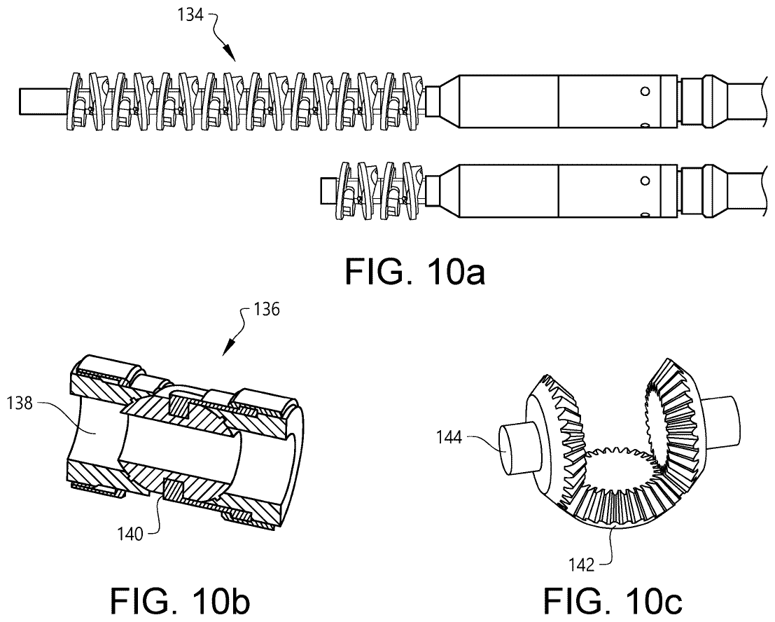

FIG. 10 illustrates add-ons to a tractor 10, according to an embodiment of the invention. As in e.g. FIG. 7a, 7b, 8a or 8b, the number of propulsion members of each one of the first and second drive portions 22, 24 may be scaled based on the requirements of the tractor apparatus and the cylindrical area the tractor 10 and/or the apparatus 108 needs to propel through. In the example in illustrated in FIG. 10a, the number of drive portions is scaled from one drive portion to three drive portions, as indicated by numeral 134 in FIG. 10a.

In another aspect, shown in FIG. 10b, one or more knuckle joints 136 may be added as an interface to the tractor 10 to increase flexibility of the apparatus to move through bends and curves. The sections 138, 140 depict front and inner faces of a knuckle joint which may be interfaced to the connecting interfaces of the tractor 10.

Contra gears as exemplified in FIG. 10c may be employed on the tractor 10 to keep the torque to a minimal for the whole assembly and prevent any additional torque forces from acting on the apparatus or eliminating turning of the apparatus. The teeth 142 and shaft 144 of the contra gears are illustrated in the drawing.

In addition, the tractor may also comprise gear boxes, return gears and mechanical additions. Gear boxes may be added to ensure optimal speed vs torque for specific operations. A return gear may be added to return the rotational direction of the tractor to reverse the running direction (i.e., of the pressure operated valve). Moreover, the tractor may comprise one or more mechanical additions such as weak-link or burst disc to protect the tractor apparatus from higher stresses caused by mechanical means and or pressure.

Purely by way of example, the tractor 10 an be provided with additional interfaces to allow selection of the number of drive portions, the number of propulsion members, such as wheels, in each of the drive portion, type of propulsion members, such as type of wheels, in the drive portions depending on the application for which the tractor 10 is employed.

Furthermore, additional fittings for bend selection of the tractor 10 to select the bending radius of the tractor 10 may also be provided.

As a non-limiting example, the individual modules, components, add-on's, and interfaces provided for the tractor may be fail safe such that they ensure the tractor apparatus does not get stuck in the cylindrical body during operations. In an example, if there are problems with pressure or flow control to the tractor 10, the tractor 10 may be reset by a mechanically activated emergency function switch, such that the apparatus continues to operate without interventions on being powered up again.

By way of example only, the tractor 10 itself may be provided with emergency tools or fail-safe mechanisms to handle emergency scenarios. These tools may include an emergency function that may be electric, time, pressure or mechanically activated. An example would be to have a smallest possible cross section in cases where the tractor needs to be retracted out of the well or pipeline it is operating in, or other cases where a minimal size is desired.

Purely by way of example, the tractor 10 may be employed in applications from the surface of the land. In such a scenario, the tractor 10 may employ its own push force to provide the required pressure to drive the apparatus. It may not be necessary to have any addition injectors or additional forces employed to attain the required pressure. A deployment lubricator may be employed by the tractor apparatus during such applications. The lubricator may be a pipe, hose, bends or combinations of these and may be directed in any angle with any bend radius or no bend radius at all. Furthermore, the apparatus may be provided with mechanism to guide the fluid supply means into the lubricator through one of: gooseneck, sheave wheels and/or roller guides.

As non-limiting alternatives, the present disclosure may be presented in accordance with any one of the following points.
Point 1. An apparatus 108 for performing operations inside a cylindrical body, the apparatus comprising:
   a fluid supply means 100 extending from a rear end of the apparatus for providing fluid to the apparatus;
   at least one pressure diversion unit 73, 75 in fluid communication with the fluid supply means 100;
   a front drive module 22 and a rear drive module 24 in fluid communication with the pressure diversion unit 73, 75; and
   a fluid motor 14 in fluid communication with the front drive module 22 and rear drive module 24, the motor being controlled by a control unit.
Point 2. The apparatus 108 according to point 1, wherein the fluid supply means for providing fluid to the apparatus 108 is at least one of: an umbilical, a hose, steel pipe threaded or non-threaded, composite.
Point 3. The apparatus 108 according to point 1, comprising a cavity/channel 114 for supply of hydraulic or pneumatic fluid, wherein the fluid drives the front drive module 22 and rear drive module 24 for propulsion of the apparatus inside a cylindrical body.
Point 4. The apparatus 108 according to point 3, wherein the hydraulic or pneumatic fluid is in communication with a hydraulic or pneumatic cylinder employed in the front drive module 22 and the rear drive module 24 of the apparatus.
Point 5. The apparatus 108 according to point 1, wherein the front drive module 22 and the rear drive module 44 comprise eccentric drives with a tilting mechanism and comprising plurality of wheels of the drive module, wherein the tilting mechanism tilts the plurality of wheels for propulsion of the apparatus in the cylindrical body.
Point 6. The apparatus 108 according to points 1-5, wherein the wheels of the front drive module 22 rotate in a counter rotate direction with respect to the wheels of the rear drive module 24.
Point 7. The apparatus 108 according to points 1-6, wherein the motor is placed between the front drive module 22 and the rear drive module 24 and rotates such that, the rotation of the motor with respect to its housing and rotor achieves the same RPM in opposite direction due to friction from the front 22 and rear drive module 24 and prevents turning of the whole apparatus during operation inside the cylindrical body.
Point 8. The apparatus 108 according to points 1-7, wherein the motor is placed either at the front of or back of the front drive module 22 and the rear drive module 24, wherein the front drive module 22 and the rear drive module 24 are connected through a shaft to each other.
Point 9. The apparatus 108 according to point 1, wherein the apparatus further comprises a central shaft extending along the inner region of the apparatus and supports different modules of the apparatus.
Point 10. The apparatus 108 according to point 1, wherein the apparatus further comprises a front pressure diversion unit 75 connected to control pressure of the front drive module 24 and a rear pressure diversion unit 73 connected to control pressure of the rear drive module 22.
Point 11. The apparatus 108 according to point 10, wherein the front and rear pressure diversion units 75, 73 distributes the hydraulic or pneumatic fluid to the front and rear drive modules 22, 24 to activate the wheels of the drive modules.
Point 12. The apparatus 108 according to point 1, wherein the apparatus further comprises an interface for providing a plurality of add-ons and scaling components.
Point 13. The apparatus 108 according to point 12, wherein the add-ons include at least one of: additional drive modules, joints, gears, weaklinks, burst discs, flow activated tools, memory tools, time activated tools and emergency tools or fail safe mechanisms.
Point 14. The apparatus 108 according to point 1, wherein the cylindrical cavity is one of: a pipeline, flowline, umbilicals, hose, flexible risers bounded and un-bounded.
Point 15. The apparatus 108 according to point 1, further comprises a sensor module with sensors for measuring temperature, fluid flow, torque, pressure, humidity.
Point 16. The apparatus 108 according to point 1, wherein the apparatus is configured to be employed from the land surface using lubricators including at least one of: pipe, hose, bends and by means of the push force of the apparatus.
Point 17. The apparatus 108 according to point 1, wherein the apparatus is configured to guide the fluid supply means into a lubricator through one of: gooseneck, sheave wheels, roller guides.

It is to be understood that the present invention is not limited to the embodiments described above and illustrated in the drawings; rather, the skilled person will recognize that many changes and modifications may be made within the scope of the appended claims.

1.-34. (canceled).

35. A tractor for propelling an apparatus inside a cylindrical body, said tractor comprising a fluid motor comprising a fluid motor fluid inlet and a fluid motor fluid exhaust, wherein said tractor further comprises a set of drive portions comprising at least one drive portion wherein each drive portion in said set of drive portions comprises:
a drive shaft connected to said fluid motor whereby said drive shaft is adapted to be rotated around an axis of rotation of said drive shaft,
a set of propulsion members comprising at least one propulsion member, preferably two or more propulsion members, each propulsion member in said set of propulsion members being rotationally fixed to said drive shaft;
a fluid actuated control assemblyadapted to control a largest distance, in a direction perpendicular to said axis of rotation of said drive shaft, from said drive shaft to each propulsion member in said set of propulsion members,
said control assembly being adapted to be at least selectively in fluid communication with at least one of said fluid motor fluid inlet and said fluid motor fluid exhaust.

36. The tractor according to claim 35, wherein said set of drive portions comprises at least two drive portions, namely a first drive portion and a second drive portion.

37. The tractor according to claim 36, wherein said fluid motor comprises a stator and a rotor, wherein the drive shaft of one of said first drive portion and said second drive portion is rotationally connected to said stator and the drive shaft of the other one of said first drive portion and said second drive portion is rotationally connected to said rotor.

38. The tractor according to claim 36, wherein the fluid actuated control assembly of one of said first drive portion and said second drive portion is adapted to be at least selectively in fluid communication with said fluid motor fluid inlet and the control assembly of the other one of said first drive portion and said second drive portion is adapted to be at least selectively in fluid communication with said fluid motor fluid exhaust.

39. The tractor according to claim 36, wherein each propulsion member in said set of propulsion members of said first drive portion is adapted to rotate in a rotational direction opposite to the rotational direction of each propulsion member in said set of propulsion members of said second drive portion.

40. The tractor according to claim 36, wherein said tractor extends along a longitudinal extension in a longitudinal direction, said set of propulsion members of said first drive portion and said set of propulsion members of said second drive portion being located on opposite sides of said fluid motor in said longitudinal direction.

41. The tractor according to claim 36, wherein said axis of rotation of said drive shaft of said first drive portion and said axis of rotation of said drive shaft of said second drive portion form an angle having an absolute value being less than 10°, preferably said axis of rotation of said drive shaft of said first drive portion is parallel to and/or coaxial with said axis of rotation of said drive shaft of said second drive portion.

42. The tractor according to claim 36, wherein at least one drive portion, preferably each drive portion, in said set of drive portions comprises a fluid flow control assembly adapted to control a flow of fluid from one of said fluid motor fluid inlet and said fluid motor fluid exhaust to said fluid actuated control assembly.

43. The tractor according to claim 42, wherein said fluid flow control assembly comprises an inlet pressure relief valve comprising an inlet pressure relief valve inlet being in fluid communication with one of said fluid motor fluid inlet and said fluid motor fluid exhaust, said inlet pressure relief valve being adapted to allow fluid passage via said inlet pressure relief valve when a fluid pressure acting on said inlet pressure relief valve inlet is equal to or exceeds a threshold inlet pressure and to prevent fluid passage via said inlet pressure relief valve when said fluid pressure acting on said inlet pressure relief valve inlet is lower than said threshold inlet pressure.

44. The tractor according to claim 35, wherein, for at least one drive portion, preferably each drive portion, in said set of drive portions, each propulsion member in said set of propulsion members comprises a rim enclosing said drive shaft, preferably each propulsion member in said set of propulsion members comprises a wheel that in turn comprises said rim.

45. The tractor according to claim 44, wherein said fluid actuated control assembly is adapted to control an eccentricity of said rim relative to said drive shaft to thereby control said largest distance, in a direction perpendicular to said axis of rotation of said drive shaft, from said drive shaft to each propulsion member in said set of propulsion members.

46. The tractor according to claim 44, wherein said rim extends in a rim plane, said rim plane forming a rim angle with said axis of rotation of the drive shaft, said rim angle being less than 90°, preferably less than 88°, more preferred less than 85°.

47. The tractor according to claim 35, wherein, for at least one drive portion, preferably each drive portion, in said set of drive portions, said control assembly comprises a fluid-controlled actuator, preferably a cylinder, adapted to increase said largest distance, in a direction perpendicular to said axis of rotation of said drive shaft, from said drive shaft to each propulsion member in said set of propulsion members, when fluid fed to said fluid-controlled actuator is equal to or above a fluid control threshold pressure.

48. The tractor according to claim 47, wherein said control assembly comprises a set of fluid-controlled actuators, such that each propulsion member in said set of propulsion members is connected to an individual fluid-controlled actuator in said set of fluid-controlled actuators, wherein each fluid-controlled actuator in said set of fluid-controlled actuators is adapted to increase said largest distance, in a direction perpendicular to said axis of rotation of said drive shaft, from said drive shaft to an individual propulsion member in said set of propulsion members, when fluid fed to said fluid-controlled actuator is equal to or above a fluid control threshold pressure.

49. The tractor according to claim 47, wherein said control assembly comprises a biasing arrangement adapted to bias each propulsion member in said set of propulsion members towards a position with a minimum largest distance, in a direction perpendicular to said axis of rotation of said drive shaft, from said drive shaft to said propulsion member.

50. The tractor according to claim 35, wherein said cylindrical body has a longitudinal extension in a longitudinal cylindrical body direction, and wherein, for at least one drive portion, preferably each drive portion, in said set of drive portions, when in use, said axis of rotation of said drive shaft and said longitudinal cylindrical body direction form an angle having an absolute value being less than 10°, preferably said axis of rotation of said drive shaft being parallel to said longitudinal cylindrical body direction.

51. The tractor according to claim 35, wherein each drive portion in said set of drive portions comprises:
a drive shaft connected to said fluid motor or connected to said fluid motor via a gear assembly, said drive shaft being adapted to be rotated around an axis of rotation of said drive shaft by said fluid motor.

52. The tractor according to claim 35, wherein said control assembly is adapted to be at least selectively in fluid communication with at least one of said fluid motor fluid inlet and said fluid motor fluid exhaust such that a single fluid flow may be used for actuating the fluid motor and for controlling the control assembly.

53. The tractor according to claim 35, wherein said fluid motor is adapted to be powered by a gas, such as air, or a liquid, such as oil or water.

54. A tractor assembly comprising the tractor according to claim 35 further comprising a fluid guide conduit adapted to guide fluid to said fluid motor fluid inlet, and a source of pressurized fluid, preferably a pump, wherein said source of pressurized fluid is in fluid communication with said fluid guide conduit.
